(19) United States
(12) Patent Application Publication
(10) Pub. No.: US 2019/0006826 A1
(43) Pub. Date: Jan. 3, 2019

(54) REINFORCED BASE PAD COVER

(71) Applicant: QUALCOMM Incorporated, San Diego, CA (US)

(72) Inventors: Simon ISLINGER, Muenchen (DE); Rafal SCIBOR, Munich (DE); Steven NIEDERHAUSER, Munich (DE)

(21) Appl. No.: 15/638,416

(22) Filed: Jun. 30, 2017

(51) Int. Cl. H02G 3/04; H02G 3/08; B60L 11/18

(52) U.S. Cl. CPC H02G 3/0418; H02G 3/081; B60L 11/1831; H02J 7/025; B60L 11/1842; B60L 2240/36; B60L 11/1818

(57) ABSTRACT

Techniques for improving the structural integrity of wireless power base and vehicle pads are provided. An example of a wireless electric vehicle pad with a foreign object detection system according to the disclosure includes a reinforced base pad cover including an interior side with a plurality of columns, and a foreign object detection loop array comprising a plurality of loop centers, the foreign object detection loop array being disposed on the interior side of the reinforced base pad cover such that each of the plurality of loop centers is disposed around a corresponding column in the plurality of columns.

### FIELD

This application is generally related to wireless power charging of chargeable devices such as electric vehicles, and more specifically to improving the structural integrity of wireless power base and vehicle pads.

### BACKGROUND

Chargeable systems, such as vehicles, have been introduced that include locomotion power derived from electricity received from an energy storage device such as a battery. Vehicles that are solely electric generally receive the electricity for charging the batteries from other sources. Battery electric vehicles are often proposed to be charged through some type of wireless charging system that is capable of transferring power in free space (e.g., via a wireless field). Some such systems may provide wireless power to the vehicle while the vehicle is located on the roadway, in motion or stationary. Foreign Object Detection (FOD) may be included with a charging system to detect objects disposed within the wireless field. In general, a FOD system utilizes impedance measurements through one or more loops to detect metallic objects in the charging path. The distance between a foreign object and the loops may impact the sensitivity of the FOD system. Most charging base pads in an electric vehicle wireless charging systems are designed to operate in harsh environments (e.g., weather, solar radiation, road debris, high loads from vehicle tires, etc.). Accordingly, the internal electronics of the base pad, such as the power transfer coils, ferrites, and FOD loops are enclosed within a protective housing. The thickness of the housing may increase the distance between a foreign object disposed on the top of the housing from the FOD loops contained within the housing.

### SUMMARY

An example of a wireless electric vehicle pad with a foreign object detection system according to the disclosure includes a reinforced base pad cover including an interior side with a plurality of columns, and a foreign object detection loop array comprising a plurality of loop centers, the foreign object detection loop array being disposed on the interior side of the reinforced base pad cover such that each of the plurality of loop centers is disposed around a corresponding column in the plurality of columns.

Implementations of such an apparatus may include one or more of the following features. A coil holder including a first side and a second side, such that the second side includes a plurality of slots and is disposed on the foreign object detection loop array such that each of the plurality of slots is disposed around a corresponding column in the plurality of columns, and at least one coil disposed on the first side of the coil holder. The foreign object detection loop array may include at least one planar substrate with a plurality of conductors disposed on or within the at least one planar substrate. The foreign object detection loop array may include at least one wire loop disposed around each of the plurality of columns. The plurality of columns and the plurality of loop centers may be rectangular, oval and/or triangular in shape. The reinforced base pad cover may be made of a polyethylene terephthalate material. At least a portion of the polyethylene terephthalate material may be between 2 mm and 4 mm thick. The wireless electric vehicle pad may include 64 columns and 64 loop centers, or 32 columns and 32 loop centers.

An example of a charging base pad according to the disclosure includes a reinforced base pad cover including an interior side with plurality of columns, a foreign object detection loop array comprising a planar substrate with a plurality of loop centers, the foreign object detection loop array being disposed on the interior side of the reinforced base pad cover such that each of the plurality of loop centers is disposed around a corresponding column in the plurality of columns, a coil holder including a first side and a second side, the second side including a plurality of slots and disposed on the foreign object detection loop array such that each of the plurality of slots is disposed around a corresponding column in the plurality of columns, and at least one coil disposed on the first side of the coil holder.

Implementations of such a charging base pad may include one or more of the following features. The at least one coil may be litz wire wound in a double-D configuration. The foreign object detection loop array may be at least one printed circuit board with a plurality of conductors disposed on or within the at least one printed circuit board. The plurality of columns, the plurality of loop centers and the plurality of slots may be rectangular, oval and/or triangular in shape. The reinforced base pad cover may be made of a polyethylene terephthalate material. At least a portion of the polyethylene terephthalate material may be between 2 mm and 4 mm thick. At least one ferrite may be disposed in proximity to the at least one coil. The charging base pad may include 64 columns, 64 loop centers and 64 slots, or 32 columns, 32 loop centers and 32 slots.

An example of a wireless charging pad with a foreign object detection system according to the disclosure includes a reinforced base pad cover including an interior side with a plurality of columns, and a foreign object detection loop array comprising a plurality of loop centers, the foreign object detection loop array being disposed on the interior side of the reinforced base pad cover such that each of the plurality of loop centers is disposed around a corresponding column in the plurality of columns.

Implementations of such a wireless charging pad may include one or more of the following features. A coil holder including a first side and a second side, such that the second side includes a plurality of slots and may be disposed on the foreign object detection loop array such that each of the plurality of slots is disposed around a corresponding column in the plurality of columns, and at least one coil may be disposed on the first side of the coil holder. The foreign object detection loop array may include at least one printed circuit board with a plurality of conductors disposed on or within the at least one printed circuit board. The foreign object detection loop array may include at least one wire loop disposed around each of the plurality of columns. The reinforced base pad cover may be made of a polyethylene terephthalate material. At least a portion of the polyethylene terephthalate material may be between 2 mm and 4 mm thick. The wireless charging pad may include 64 columns and 64 loop centers and/or 32 columns and 32 loop centers.

Items and/or techniques described herein may provide one or more of the following capabilities, as well as other capabilities not mentioned. A charging base pad may include a reinforced base pad cover and a foreign object detection array. The foreign object detection array may include a plurality of loops, with each loop including a loop center. The reinforced base pad cover may include columns configured to fit into the loop centers. The thickness of the reinforced base pad cover may be reduced in the areas above the foreign object detection loops. The reduction of thickness may increase the sensitivity of the foreign object detection array. The columns increase the thickness of the reinforced base pad cover in the areas of the loop centers. The increase of thickness increases the structural integrity of the charging base pad assembly. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 is a diagram of an exemplary wireless power transfer system for charging an electric vehicle.

FIG. 2 is a schematic diagram of exemplary core components of the wireless power transfer system of FIG. 1.

FIG. 3 is another functional block diagram showing exemplary core and ancillary components of the wireless power transfer system of FIG. 1.

FIG. 4 is a perspective illustration of a magnetic flux device with a foreign object.

FIGS. 5A and 5B are perspective illustrations of an example foreign object detection (FOD) array.

FIG. 6A are perspective and side view diagrams of a reinforced base pad cover and FOD loop array.

FIG. 6B are perspective and side view diagrams of the reinforced base pad cover and the FOD loop array of FIG. 6A in assembled positions.

FIG. 7A is a perspective view of a coil and a coil holder assembly.

FIG. 7B are perspective and side view diagrams of the reinforced base pad cover, FOD loop array, coil holder and coil in assembled positions.

FIG. 8 is a perspective diagram of an example charging base pad with a reinforced base pad cover.

FIGS. 9A-9J are examples of FOD loop structures.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and form part of this disclosure.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer. Foreign objects disposed within the wireless field may degrade the power transfer and/or create safety issues due to heat generated within the foreign object.

In wireless charging systems, Foreign Object Detection (FOD) systems are utilized to protect the physical power transfer process. A FOD system may include one or more conducting loops configured to detect changes in magnetic flux due to the presence of a metallic object in the wireless field. A FOD system should be capable of detecting metallic objects of small sizes (e.g., the size of coin or a paperclip). To meet such requirements, the distance between the FOD loops and the foreign metallic object should be minimized. One challenge is the need for a robust base pad cover to provide protection to the base pad electronics as well as provide structural strength to the base pad assembly. A base pad cover constructed of a relatively thicker material may provide better structural support, but the thickness may increase the distance between the FOD loops located within the base pad cover and a foreign object disposed outside of the cover. Reducing the thickness of the base pad cover may improve the sensitivity of the FOD system at the risk of reducing the structural integrity of the base pad. The reduced cover thickness may also be used to increase the sensitivity of a FOD system in an electric vehicle pad where the FOD system may be disposed above the ground (e.g., on the bottom of a vehicle) and further away from a foreign object on the ground.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

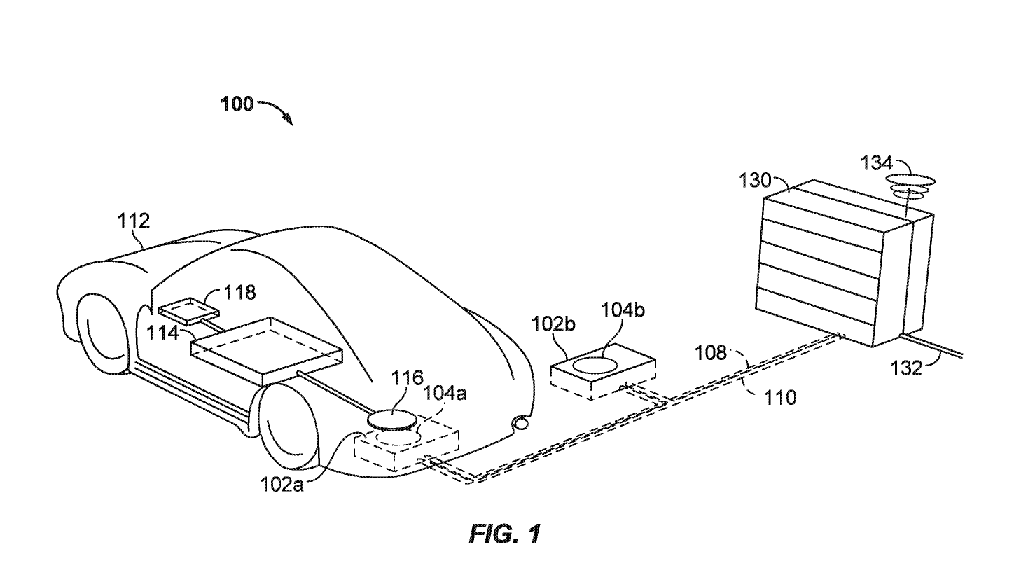

Referring to FIG. 1, a diagram of an exemplary wireless power transfer system 100 for charging an electric vehicle 112 is shown. The wireless power transfer system 100 enables charging of an electric vehicle 112 while the electric vehicle 112 is parked near a base wireless charging system 102a. Spaces for two electric vehicles are illustrated in a parking area to be parked over corresponding base wireless charging system 102a and 102b. In some embodiments, a local distribution center 130 may be connected to a power backbone 132 and configured to provide an alternating current (AC) or a direct current (DC) supply through a power link 110 to the base wireless charging system 102a. The base wireless charging system 102a also includes a base system induction coil 104a for wirelessly transferring or receiving power. The wireless charging system 102a may include a reinforced base pad cover configured to enclose and protect the base system induction coil 104a and other components in the wireless charging system 102a. The second wireless charging system 102b includes a second base system induction coil 104b. An electric vehicle 112 may include a battery unit 118, an electric vehicle induction coil 116, and an electric vehicle wireless charging system 114. The electric vehicle induction coil 116 may interact with the base system induction coil 104a for example, via a region of the electromagnetic field generated by the base system induction coil 104a.

In some exemplary embodiments, the electric vehicle induction coil 116 may receive power when the electric vehicle induction coil 116 is located in an energy field produced by the base system induction coil 104a. The field corresponds to a region where energy output by the base system induction coil 104a may be captured by an electric vehicle induction coil 116. For example, the energy output by the base system induction coil 104a may be at a level sufficient to charge or power the electric vehicle 112. In some cases, the field may correspond to the “near field” of the base system induction coil 104a. The near-field may correspond to a region in which there are strong reactive fields resulting from the currents and charges in the base system induction coil 104a that do not radiate power away from the base system induction coil 104a. In some cases the near-field may correspond to a region that is within about ½π of wavelength of the base system induction coil 104a (and vice versa for the electric vehicle induction coil 116) as will be further described below. Local distribution 130 may be configured to communicate with external sources (e.g., a power grid) via a communication backhaul 134, and with the base wireless charging system 102a via a communication link 108.

In some embodiments the electric vehicle induction coil 116 may be aligned with the base system induction coil 104a and, therefore, disposed within a near-field region simply by the driver positioning the electric vehicle 112 correctly relative to the base system induction coil 104a. In other embodiments, the driver may be given visual feedback, auditory feedback, or combinations thereof to determine when the electric vehicle 112 is properly placed for wireless power transfer. In yet other embodiments, the electric vehicle 112 may be positioned by an autopilot system, which may move the electric vehicle 112 back and forth (e.g., in zig-zag movements) until an alignment error has reached a tolerable value. This may be performed automatically and autonomously by the electric vehicle 112 without or with only minimal driver intervention provided that the electric vehicle 112 is equipped with a servo steering wheel, ultrasonic sensors, and intelligence to adjust the vehicle. In still other embodiments, the electric vehicle induction coil 116, the base system induction coil 104a, or a combination thereof may have functionality for displacing and moving the induction coils 116 and 104a relative to each other to more accurately orient them and develop more efficient coupling therebetween.

The base wireless charging system 102a may be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly may provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 100. Manipulations with cables and connectors may not be needed, and there may be no cables, plugs, or sockets that may be exposed to moisture and water in an outdoor environment, thereby improving safety. There may also be no sockets, cables, and plugs visible or accessible, thereby reducing potential vandalism of power charging devices. Further, since an electric vehicle 112 may be used as distributed storage devices to stabilize a power grid, a docking-to-grid solution may be used to increase availability of vehicles for Vehicle-to-Grid (V2G) operation.

A wireless power transfer system 100 as described with reference to FIG. 1 may also provide aesthetical and non-impedimental advantages. For example, there may be no charge columns and cables that may be impedimental for vehicles and/or pedestrians. A potential safety issue, however, may arise when metallic foreign objects are located in the near-field generated by the base system induction coil 104a or the vehicle induction coil 116 (e.g., in a V2G configuration). The magnetic energy in the near-field may be transformed into thermal energy within a metallic foreign object, thus creating a fire hazard.

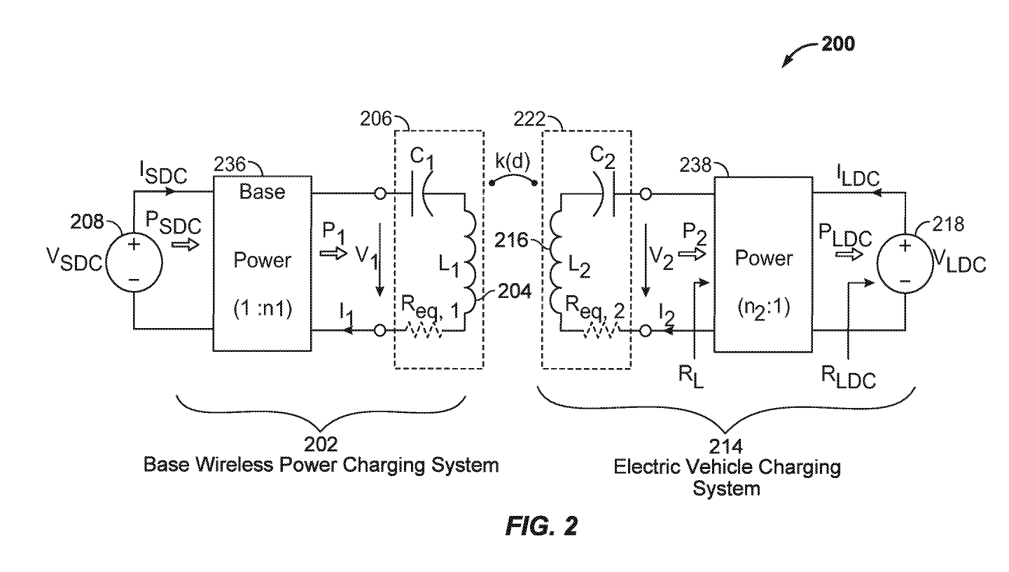

Referring to FIG. 2, a schematic diagram of exemplary core components of the wireless power transfer system 100 of FIG. 1 is shown. The wireless power transfer system 200 may include a base system transmit circuit 206 including a base system induction coil 204 having an inductance L1. The wireless power transfer system 200 further includes an electric vehicle receive circuit 222 including an electric vehicle induction coil 216 having an inductance L¬2. Embodiments described herein may use capacitively loaded wire loops (i.e., multi-turn coils) forming a resonant structure that is capable of efficiently coupling energy from a primary structure (transmitter) to a secondary structure (receiver) via a magnetic or electromagnetic near field if both primary and secondary are tuned to a common resonant frequency. The coils may be used for the electric vehicle induction coil 216 and the base system induction coil 204. Using resonant structures for coupling energy may be referred to “magnetic coupled resonance,” “electromagnetic coupled resonance,” and/or “resonant induction.” The operation of the wireless power transfer system 200 will be described based on power transfer from a base wireless power charging system 202 to an electric vehicle 112, but is not limited thereto. For example, as discussed above, the electric vehicle 112 may transfer power to the base wireless charging system 102a.

A power supply 208 (e.g., AC or DC) supplies power PSDC to the base wireless power charging system 202 to transfer energy to an electric vehicle 112. The base wireless power charging system 202 includes a base charging system power converter 236. The base charging system power converter 236 may include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P1 to the base system transmit circuit 206 including the capacitor C1 in series with the base system induction coil 204 to emit an electromagnetic field at a desired frequency. The capacitor C1 may be provided to form a resonant circuit with the base system induction coil 204 that resonates at a desired frequency. The base system induction coil 204 receives the power P1 and wirelessly transmits power at a level sufficient to charge or power the electric vehicle 112. For example, the power level provided wirelessly by the base system induction coil 204 may be on the order of kilowatts (kW) (e.g., anywhere from 1 kW to 110 kW or higher or lower).

The base system transmit circuit 206 including the base system induction coil 204 and electric vehicle receive circuit 222 including the electric vehicle induction coil 216 may be tuned to substantially the same frequencies and may be positioned within the near-field of an electromagnetic field transmitted by one of the base system induction coil 204 and the electric vehicle induction coil 116. In this case, the base system induction coil 204 and electric vehicle induction coil 116 may become coupled to one another such that power may be transferred to the electric vehicle receive circuit 222 including capacitor C2 and electric vehicle induction coil 116. The capacitor C2 may be provided to form a resonant circuit with the electric vehicle induction coil 216 that resonates at a desired frequency. Element k(d) represents the mutual coupling coefficient resulting at coil separation. Equivalent resistances Req,1 and Req,2 represent the losses that may be inherent to the induction coils and 216 and the anti-reactance capacitors C1 and C2. The electric vehicle receive circuit 222 including the electric vehicle induction coil 316 and capacitor C2 receives power P2 and provides the power P2 to an electric vehicle power converter 238 of an electric vehicle charging system 214.

The electric vehicle power converter 238 may include, among other things, a LF/DC converter configured to convert power at an operating frequency back to DC power at a voltage level matched to the voltage level of an electric vehicle battery unit 218. The electric vehicle power converter 238 may provide the converted power PLDC to charge the electric vehicle battery unit 218. The power supply 208, base charging system power converter 236, and base system induction coil 204 may be stationary and located at a variety of locations as discussed above. The battery unit 218, electric vehicle power converter 238, and electric vehicle induction coil 216 may be included in an electric vehicle charging system 214 that is part of electric vehicle 112 or part of the battery pack (not shown). The electric vehicle charging system 214 may also be configured to provide power wirelessly through the electric vehicle induction coil 216 to the base wireless power charging system 202 to feed power back to the grid. Each of the electric vehicle induction coil 216 and the base system induction coil 204 may act as transmit or receive induction coils based on the mode of operation.

While not shown, the wireless power transfer system 200 may include a load disconnect unit (LDU) to safely disconnect the electric vehicle battery unit 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle induction coil 216 to the electric vehicle power converter 238. Disconnecting the electric vehicle induction coil 216 may suspend charging and also may adjust the “load” as “seen” by the base wireless charging system 102a (acting as a transmitter), which may be used to “cloak” the electric vehicle wireless charging system 114 (acting as the receiver) from the base wireless charging system 102a. The load changes may be detected if the transmitter includes the load sensing circuit. Accordingly, the transmitter, such as a base wireless charging system 202, may have a mechanism for determining when receivers, such as an electric vehicle wireless charging system 114, are present in the near-field of the base system induction coil 204.

As described above, in operation, assuming energy transfer towards the vehicle or battery, input power is provided from the power supply 208 such that the base system induction coil 204 generates a field for providing the energy transfer. The electric vehicle induction coil 216 couples to the field and generates output power for storage or consumption by the electric vehicle 112. As described above, in some embodiments, the base system induction coil 204 and electric vehicle induction coil 116 are configured according to a mutual resonant relationship such that when the resonant frequency of the electric vehicle induction coil 116 and the resonant frequency of the base system induction coil 204 are very close or substantially the same. Transmission losses between the base wireless power charging system 202 and electric vehicle charging system 214 are minimal when the electric vehicle induction coil 216 is located in the near-field of the base system induction coil 204.

As stated, an efficient energy transfer occurs by coupling a large portion of the energy in the near field of a transmitting induction coil to a receiving induction coil rather than propagating most of the energy in an electromagnetic wave to the far-field. When in the near field, a coupling mode may be established between the transmit induction coil and the receive induction coil. The area around the induction coils where this near field coupling may occur is referred to herein as a near field coupling mode region.

While not shown, the base charging system power converter 236 and the electric vehicle power converter 238 may both include an oscillator, a driver circuit such as a power amplifier, a filter, and a matching circuit for efficient coupling with the wireless power induction coil. The oscillator may be configured to generate a desired frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance of the power conversion module to the wireless power induction coil. The power converters 236 and 238 may also include a rectifier and switching circuitry to generate a suitable power output to charge the battery.

The electric vehicle induction coil 216 and base system induction coil 204 as described throughout the disclosed embodiments may be referred to or configured as “loop” antennas, and more specifically, multi-turn loop antennas. The induction coils 204 and 216 may also be referred to herein or be configured as “magnetic” antennas. The term “coil” generally refers to a component that may wirelessly output or receive energy four coupling to another “coil.” The coil may also be referred to as an “antenna” of a type that is configured to wirelessly output or receive power. As used herein, coils 204 and 216 are examples of “power transfer components” of a type that are configured to wirelessly output, wirelessly receive, and/or wirelessly relay power. Loop (e.g., multi-turn loop) antennas may be configured to include an air core or a physical core such as a ferrite core. An air core loop antenna may allow the placement of other components within the core area. Physical core antennas including ferromagnetic or ferromagnetic materials may allow development of a stronger electromagnetic field and improved coupling. The coils may be litz wire.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency may be based on the inductance and capacitance of a transmit circuit including an induction coil (e.g., the base system induction coil 204) as described above. Inductance may generally be the inductance of the induction coil, whereas, capacitance may be added to the induction coil to create a resonant structure at a desired resonant frequency. As a non-limiting example, as shown in FIG. 2, a capacitor may be added in series with the induction coil to create a resonant circuit (e.g., the base system transmit circuit 206) that generates an electromagnetic field. Accordingly, for larger diameter induction coils, the value of capacitance needed to induce resonance may decrease as the diameter or inductance of the coil increases. Inductance may also depend on a number of turns of an induction coil. Furthermore, as the diameter of the induction coil increases, the efficient energy transfer area of the near field may increase. Other resonant circuits are possible. As another non limiting example, a capacitor may be placed in parallel between the two terminals of the induction coil (e.g., a parallel resonant circuit). Furthermore an induction coil may be designed to have a high native quality (Q) factor to lower the losses of the induction coil and to increase efficiency of the inductive coupling system.

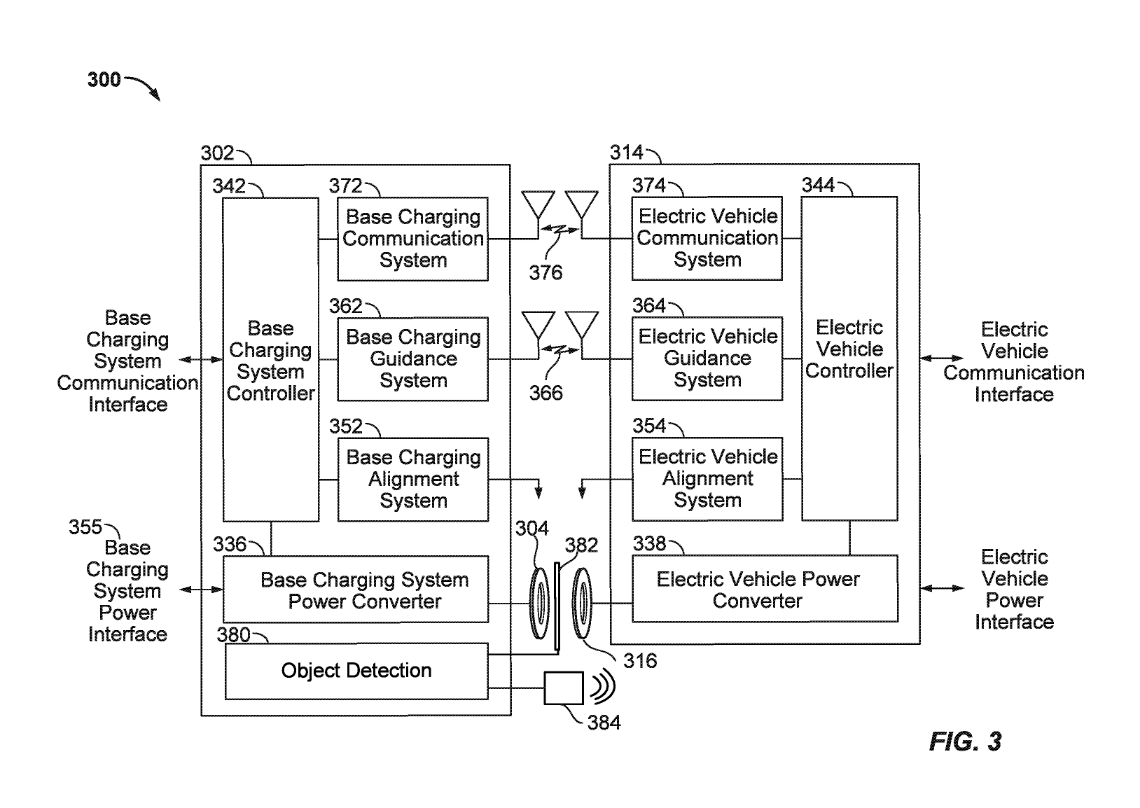

Referring to FIG. 3, another functional block diagram showing exemplary core and ancillary components of the wireless power transfer system 300 of FIG. 1 is shown. The wireless power transfer system 300 illustrates a object detection controller 380, a communication link 376, a guidance link 366, and alignment systems 352, 354 for the base system induction coil 304 and electric vehicle induction coil 316. In an example, the power transfer system 300 may include a pairing device (not shown in FIG. 3) to certify the matching of the transmitting entity and the receiving entity of alignment and guidance. As described above with reference to FIG. 2, and assuming energy flow towards the electric vehicle 112, in FIG. 3 a base charging system power interface 355 may be configured to provide power to a base charging system power converter 336 from a power source, such as an AC or DC power supply. The base charging system power converter 336 may receive AC or DC power from the base charging system power interface 355 to excite the base system induction coil 304 at or near its resonant frequency. The electric vehicle induction coil 316, when in the near field coupling-mode region, may receive energy from the near field coupling mode region to oscillate at or near the resonant frequency. The electric vehicle power converter 338 converts the oscillating signal from the electric vehicle induction coil 316 to a power signal suitable for charging a battery via the electric vehicle power interface.

The base wireless charging system 302 includes a base charging system controller 342 and the electric vehicle charging system 314 includes an electric vehicle controller 344. The base charging system controller 342 may include a base charging system communication interface to other systems (not shown) such as, for example, a computer, and a power distribution center, or a smart power grid. The electric vehicle controller 344 may include an electric vehicle communication interface to other systems (not shown) such as, for example, an on-board computer on the vehicle, other battery charging controller, other electronic systems within the vehicles, and remote electronic systems.

The base charging system controller 342 and electric vehicle controller 344 may include subsystems or modules for specific application with separate communication channels. These communications channels may be separate physical channels or separate logical channels. As non-limiting examples, a base charging alignment system 352 may communicate with an electric vehicle alignment system 354 through a communication link 376 to provide a feedback mechanism for more closely aligning the base system induction coil 304 and electric vehicle induction coil 316, either autonomously or with operator assistance. Similarly, a base charging guidance system 362 may communicate with an electric vehicle guidance system 364 through a guidance link to provide a feedback mechanism to guide an operator in aligning the base system induction coil 304 and electric vehicle induction coil 316. The base charging system controller 342 may be operably coupled to an object detection controller 380 configured to control a foreign object detection (FOD) system 382 and a living object protection (LOP) system 384. In addition, there may be separate general-purpose communication links (e.g., channels) supported by base charging communication system 372 and electric vehicle communication system 374 for communicating other information between the base wireless charging system 302 and the electric vehicle charging system 314. This information may include information about electric vehicle characteristics, battery characteristics, charging status, and power capabilities of both the base wireless charging system 302 and the electric vehicle charging system 314, foreign object detection, living object protection information, as well as maintenance and diagnostic data for the electric vehicle 112. The base charging system controller may also have a Human Machine Interface (HMI) to receive input from a user such as an indication that the charging area is free from foreign objects. An emergency off button may also be part of the interface. These communication channels may be separate physical communication channels such as, for example, Bluetooth, zigbee, cellular, etc.

Electric vehicle controller 344 may also include a battery management system (BMS) (not shown) that manages charge and discharge of the electric vehicle principal battery, a parking assistance system based on microwave or ultrasonic radar principles, a brake system configured to perform a semi-automatic parking operation, and a steering wheel servo system configured to assist with a largely automated parking ‘park by wire’ that may provide higher parking accuracy, thus reducing the need for mechanical horizontal induction coil alignment in any of the base wireless charging system 102a and the electric vehicle wireless charging system 114. Further, electric vehicle controller 344 may be configured to communicate with electronics of the electric vehicle 112. For example, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

The wireless power transfer system 300 includes detection and sensor systems for use with systems to properly guide the driver or the vehicle to the charging spot and sensors to mutually align the induction coils with the required separation/coupling. The LOP system 384 includes sensors to detect objects that may obstruct the electric vehicle induction coil 316 from moving to a particular height and/or position to achieve coupling, and safety sensors for use with systems to perform a reliable, damage free, and safe operation of the system. For example, the LOP system 384 may include a sensor for detection of presence of animals or children approaching the wireless power induction coils 104a, 116 beyond a safety radius. The FOD system 382 is configured to detect foreign metal objects near the base system induction coil 304 that may be heated up (induction heating). Other sensors may be used for the detection of hazardous events such as incandescent objects on the base system induction coil 304, and temperature monitoring of the base wireless charging system 302 and electric vehicle charging system 314 components.

The wireless power transfer system 300 may also support plug-in charging via a wired connection. A wired charge port may integrate the outputs of the two different chargers prior to transferring power to or from the electric vehicle 112. Switching circuits may provide the functionality as needed to support both wireless charging and charging via a wired charge port.

To communicate between a base wireless charging system 302 and an electric vehicle charging system 314, the wireless power transfer system 300 may use both in-band signaling and an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

In addition, some communication may be performed via the wireless power link without using specific communications antennas. For example, the wireless power induction coils 304 and 316 may also be configured to act as wireless communication transmitters. Thus, some embodiments of the base wireless charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base charging system power converter 336 may include a load sensing circuit (not shown) for detecting the presence or absence of active electric vehicle receivers in the vicinity of the near field generated by the base system induction coil 304. By way of example, a load sensing circuit monitors the current flowing to the power amplifier, which is affected by the presence or absence of active receivers in the vicinity of the near field generated by base system induction coil 104a. Detection of changes to the loading on the power amplifier may be monitored by the base charging system controller 342 for use in determining whether to enable the oscillator for transmitting energy, to communicate with an active receiver, or a combination thereof.

To enable wireless high power transfer, some embodiments may be configured to transfer power at a frequency in the range from 10-150 kHz and particularly in the range from 80-90 kHz. This low frequency coupling may allow highly efficient power conversion that may be achieved using solid state devices. In addition, there may be less coexistence issues with radio systems compared to other bands.

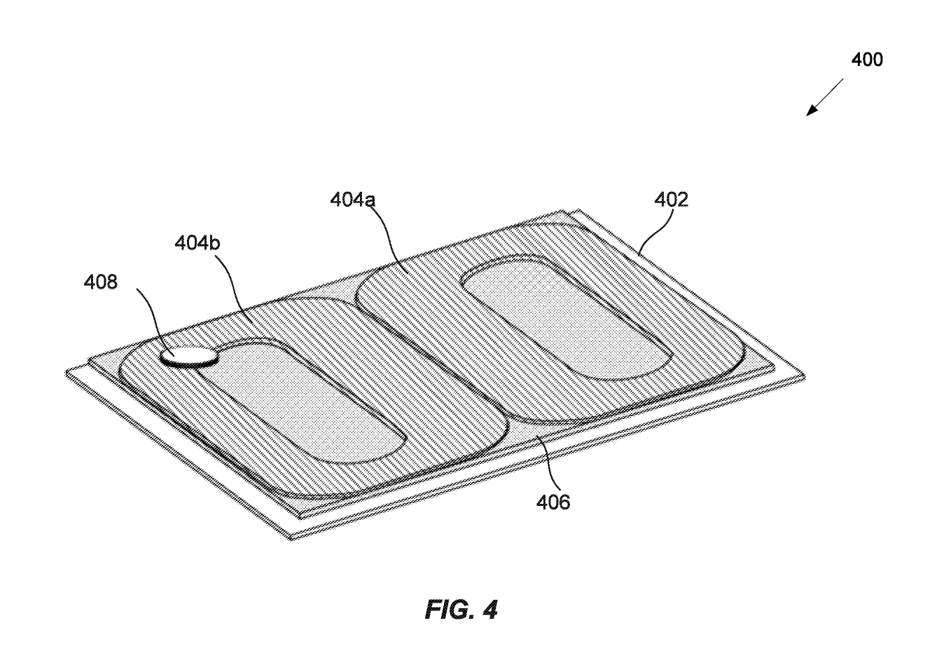

Referring to FIG. 4, with further reference to FIG. 3, a perspective illustration 400 of a magnetic flux device 402 with a foreign object 408 is shown. As an example, the magnetic flux device 402 is configured as a double-D, full-size coil with a ferrite layer configured to transmit or receive magnetic flux to or from a space beyond the magnetic flux device. The double-D configuration is exemplary only and not a limitation as other configurations such as circular, bi-polar, and solenoid type may be used. As used herein, the term “magnetic flux device” has its broadest reasonable interpretation, including but not limited to, a base pad (e.g., base system induction coil 304), a vehicle pad, or other type of magnetic flux pad, and is not restricted to any particular shape, dimensions, or combination of components. As used herein, the term “pad” has its broadest reasonable interpretation, including but not limited to, a device (e.g., a base pad, a vehicle pad) configured for use in a wireless electric vehicle charging system, and is not restricted to any particular shape, dimensions, or combination of components. The magnetic flux device 402 comprises at least a first electrically conductive coil 404a and a second electrically conductive coil 404b. The first and second coils 404a-b may be wound litz wire or other conductive material. The first coil 404a is substantially planar and has a first periphery bounding a first area. The second coil 404b is substantially planar and has a second periphery bounding a second area. The second coil 404b is substantially coplanar with the first coil 404a. The magnetic flux device 402 further comprises a magnetically permeable material 406 having a substantially planar surface and having a third periphery bounding a third area. The magnetically permeable material 406 is sometimes referred to herein as a “core.” As used herein, the term “core” has its broadest reasonable interpretation, which in particular, is not to limited to being in a central location or being wrapped around by other components. The magnetically permeable material 406 can be magnetically associated with at least the first coil 404a and the second coil 404b. The first coil 404a and the second coil 404b are substantially parallel to the substantially planar surface. A ratio of a sum of the first area and the second area to the third area is in a range between 0.9 and 1.1. The magnetic flux device 402 may be enclosed in an insulating shell (not shown) to provide electrical isolation and protection from the environment. A foreign object 408 is located within the area of magnetic flux transmitted by the magnetic flux device 402. The foreign object 408 represents any metallic object such as coins, nuts, bolts, washers, beverage cans, or any other metallic object that may be found in proximity to the magnetic flux device 402 and creating a potential safety hazard due to induction heating of the foreign object.

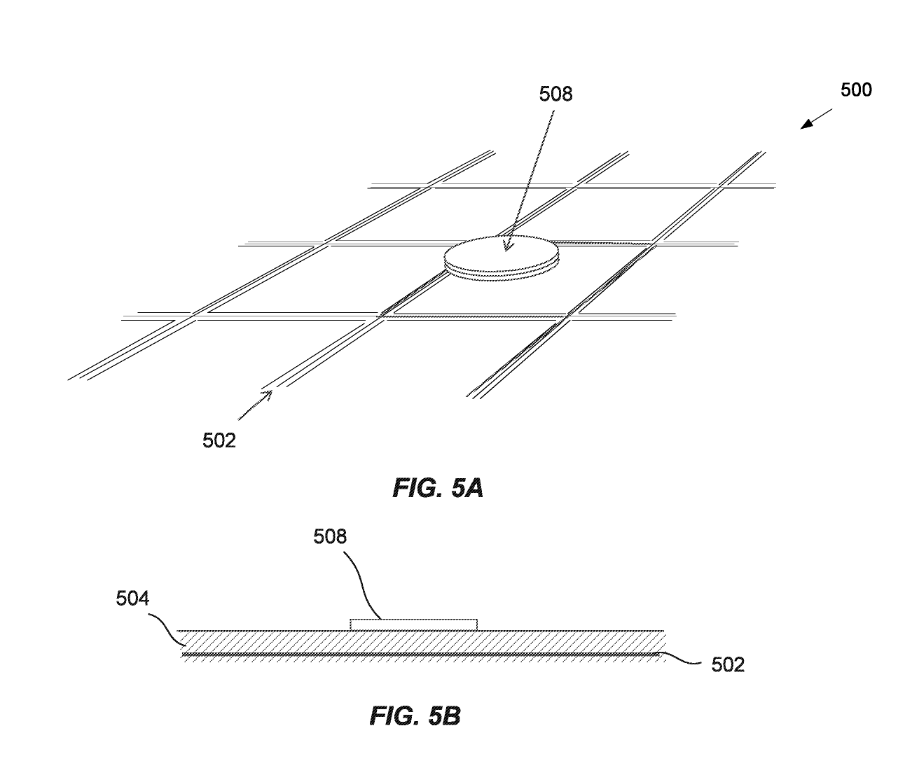

Referring to FIGS. 5A and 5B, perspective illustrations of an example foreign object (FOD) array 500 are shown. The array 500 includes a plurality of conductive wire loops 502. A foreign object 508 is disposed above the array 500. The array 500 may be disposed above a magnetic flux device 402 such as the base inductor 304. For example, referring to FIG. 5B, the loops 502 may be enclosed in a non-conductive housing 504 and the foreign object 508 may be located on the exterior of the housing 504. As an example, the distance between the loops 502 and the foreign object may be between 1 and 10 mm. In operation, loops 502 in the array 500 are a collection of small metal detectors. The loops 502 may be conductors integrated into a printed circuit board (PCB) material. The presence of a metallic object near the loops 502 changes the impedance of the loops. The change in impedance may be measured and evaluated. In an example Wireless Electric Vehicle Charging (WEVC) base pad, the array 500 includes 64 loops divided into 4 subsystems (i.e., 16 loops per subsection). The loops 502 may have an operating frequency of 2.5-3.5 MHz based on a wireless power transfer frequency of 80-90 kHz. Other loop frequencies may be used to provide adequate separation from the power transfer frequency. The object detection controller 380 may be configured to evaluate each subsection 6.25 time per second. Other sampling frequencies may also be used. The wireless power transfer between the base pad and the vehicle may cause such an undetected metallic object to heat up. A heated metal object may damage the insulation on the base pad, start a fire, create a burn hazard, or any combination of such dangers.

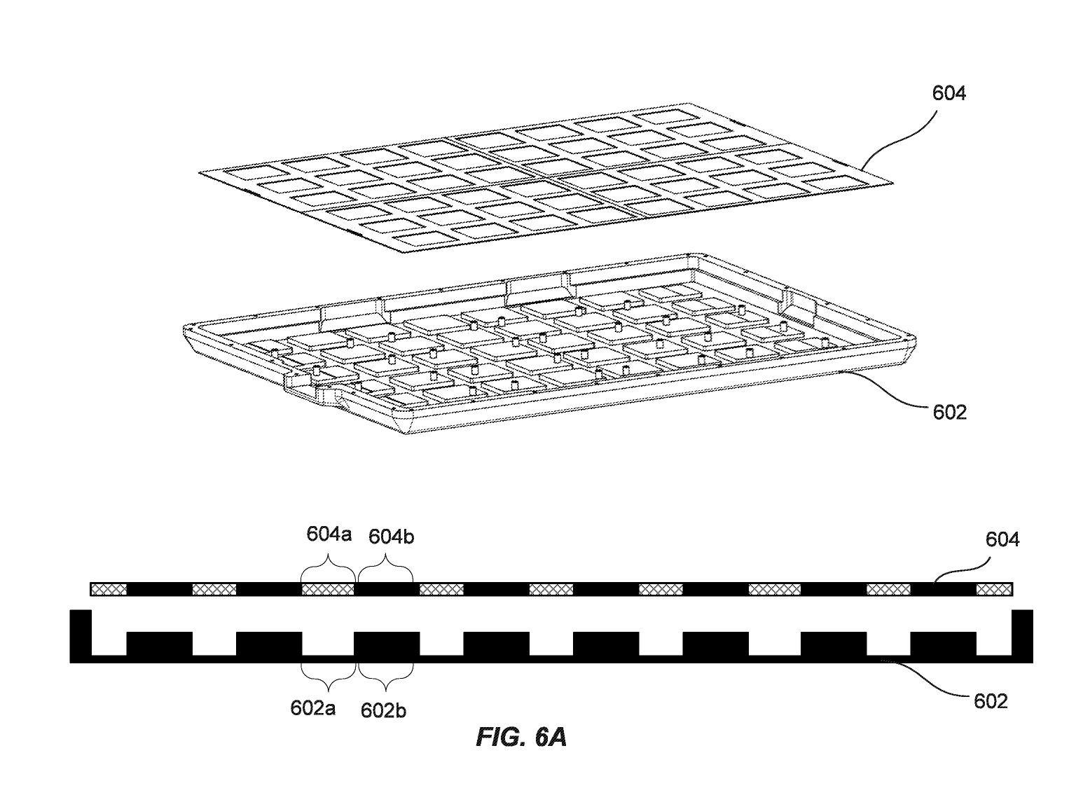

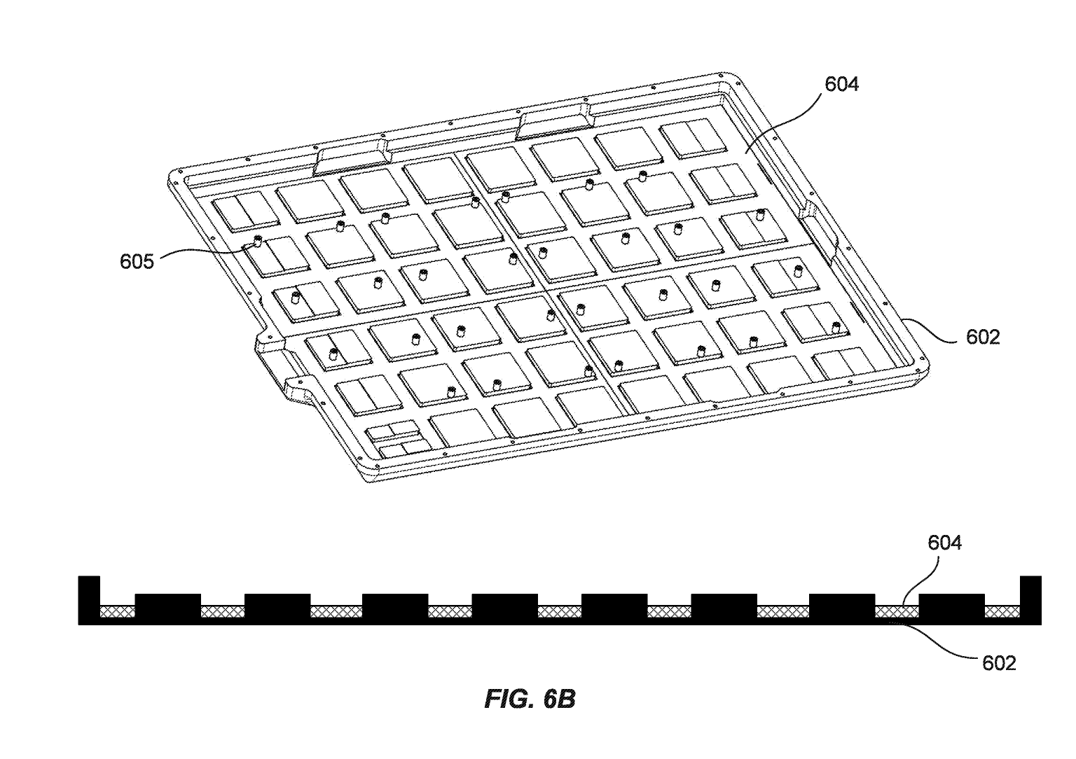

Referring to FIG. 6A, perspective and side view diagrams of a reinforced base pad cover 602 and a FOD loop array 604 are shown. The reinforced base pad cover 602 includes an exterior side which is exposed to a working environment and an interior side which faces the electronic components within the charging base pad. The reinforced base pad cover 602 may be fabricated from an industrial plastic such as polyethylene terephthalate (PET) and includes a plurality of columns 602b and intervening cover via areas 602a on the interior side. In an embodiment, the reinforced base pad cover 602 may include a plurality of assembly channels 605 configured to allow a fastener (e.g., screw/bolt) to secure the base pad cover 602 to a back cover or other charging base pad components. The FOD loop array 604 is disposed on the interior side of the cover and may be a planar substrate with one or more conductive FOD loops. For example, the FOD loop array 604 may be a printed circuit board material such as FR-4 glass epoxy with wire conductors to form a plurality of loops. The PCB material at the center of each of the loops may be removed to form a plurality of loop centers 604b and corresponding PCB via areas 604a. The PCB via areas 604a may include the conductors for the FOD loops. The dimensions of the columns 602b are configured to the inner dimensions of the loop centers 604b such that the loop centers 604b may accommodate the corresponding columns 602b. The PCB via areas 604a are configured to fit into the cover via areas 602a. Referring to FIG. 6B, perspective and side view diagrams of the reinforced base pad cover 602 and the FOD loop array 604 are shown in an assembled position. The FOD loop array 604 is configured to fit within the cover 602 such that an FOD loop is formed around each of the columns 602b. The dimensions and number of columns 602b in the cover 602 are examples only as different column densities and dimensions may be used. The columns 602b increase the structural integrity of the combination of the FOD loop array 604 and the cover 602 by allowing the more resilient cover material (e.g., PET) to fill the void of the loop centers 604b. The sensitivity of the FOD loops may be increased because the FOD loops may be disposed closer to the surface of the cover 602. For example, the thickness of the cover material in the cover via areas 602a may be approximately 3 mm thick (e.g., 2-4 mm). The thickness of the columns 602b may vary based on the thickness of the FOD loop array 604 as well as other components within a charging base pad. In an embodiment, the reinforced base pad cover 602 may be used as a vehicle pad cover with a FOD array on the vehicle side of an electric vehicle charging system.

In an embodiment, a FOD loop array may be wound within the cover 602. That is, the FOD loops may be wound around the columns 602b and thus eliminating the requirement for the PCB material used in the FOD loop array 604. For example, the cover via areas 602a and the columns 602b may be configured as a FOD loop holder and sized to accommodate one or more wire loops around each column 602b. The diameter of the wire may be substantially the same as the thickness of a PCB material used in the FOD loop array 604. Other wire diameters and winding configurations may be used to minimize potential gaps between the FOD loops and other components stacked within the base pad.

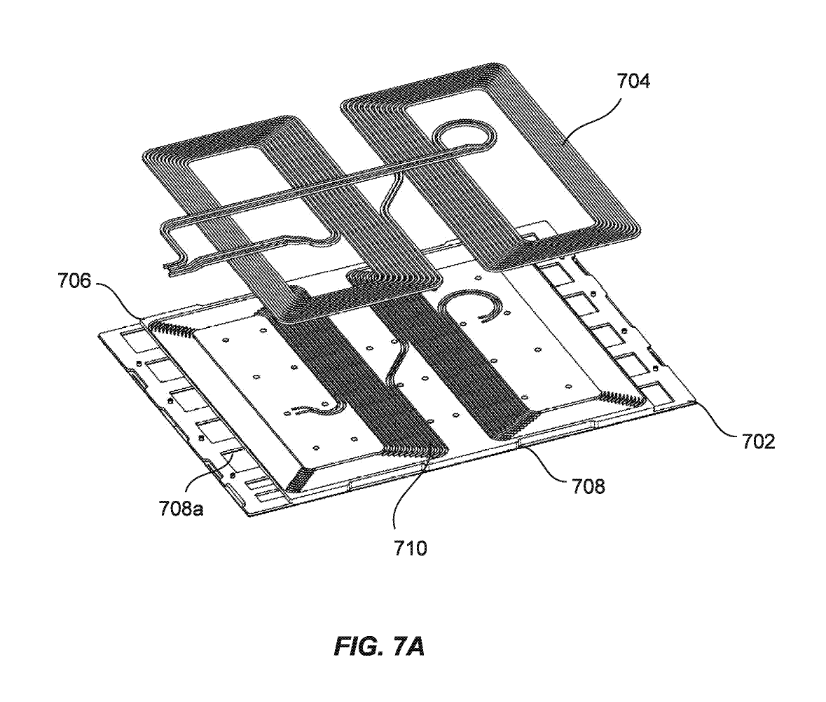

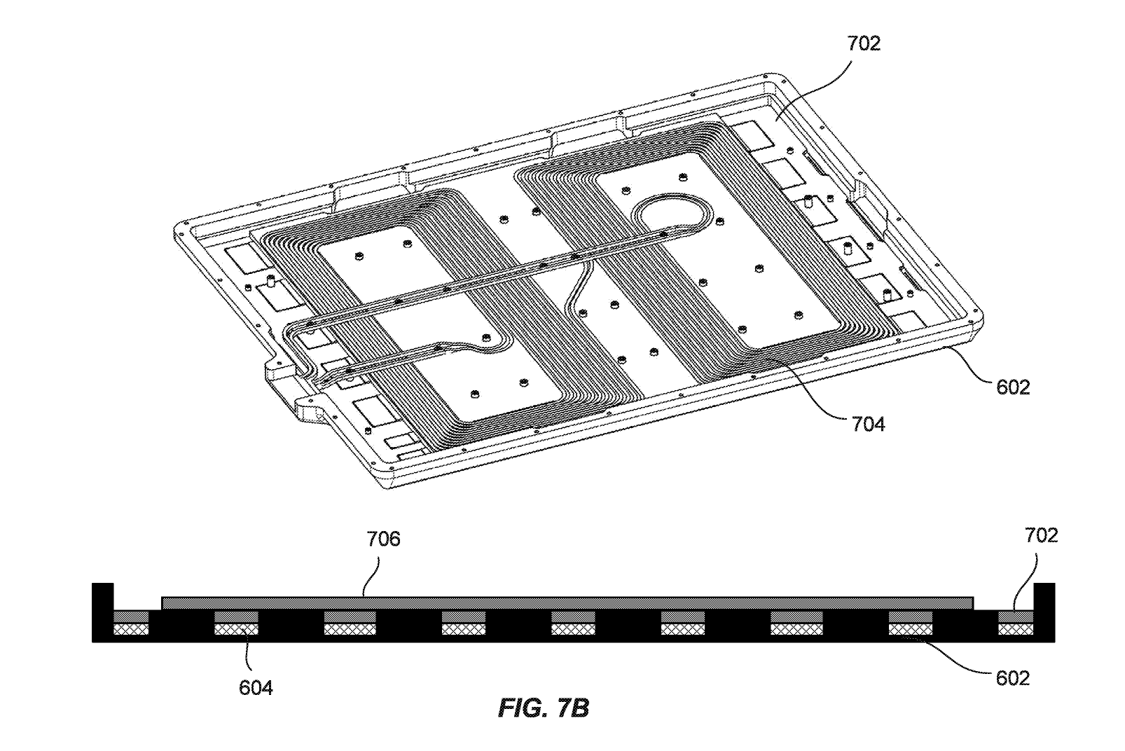

Referring to FIG. 7A, with further reference to FIG. 6A, a perspective view of a coil 704 and a coil holder assembly 702 is shown. The coil 704 is an example magnetic flux device 402 including windings of bifilar litz wire. Other conductive materials and coil configurations may be used. For example, the coil holder assembly 702 may be configured based on other magnetic flux devices such as circular, bi-polar, and solenoid type devices. The coil holder assembly 702 may be constructed of an industrial plastic (e.g., PET) and includes a first side 706 and a second side 708. In an example, the first side of the coil holder assembly 702 is designed to secure the coil 704 in a double-D configuration. The first side 706 may include one or more wire guide channels 710 configured to secure the conductive material (e.g., litz wire) in a desired position and orientation. The second side 708 of the coil holder assembly 702 may be a planar surface with a plurality of slots 708a milled into the surface. The slots 708a may extend partially into or through portions of the coil holder assembly 702. The number and the dimensions of the slots 708a correspond to the number and dimensions of the columns 602b in the cover 602. The second side 708 may be patterned to copy the FOD loop array 604 such that the slots 708a are the same dimensions as the FOD loop centers 604b, and the remaining portion of the second side conforms to the FOD vias areas 604a. The first side 706 and the second side 708 may be two separate assemblies which are fastened to one another via an adhesive, thermal welding, or other fastening techniques. In an example, the coil holder assembly 702 is a single piece of PET or other industrial plastic which has been machined or formed (e.g., mold injection) to form the first side 706 and the second side 708.

Referring to FIG. 7B, with further reference to FIG. 6A, perspective and side view diagrams of the reinforced base pad cover 602, the FOD loop array 604, coil holder 702 and coil 704 in assembled positions is shown. The coil holder 702 is configured to fit securely over the FOD loop array 604 and corresponding columns 602b. The height of the columns 602b is substantially (e.g., +/−0.1 mm) the same as the combined thickness of the FOD loop array 604 and the second side 708 of the coil holder 702. The dimensions of the combined structure are selected to minimize gaps between the cover 602, the FOD loop array 604 and the coil holder 702 such that an exterior load applied to the cover 602 is transferred through the internal components without undue flexing or relative movement between the components. The tolerances between the outer diameters of columns 602b and the inner diameters of the respective loop centers 604b and slots 708a may be in the range of 0.1-0.5 mm. The tolerances may be adjusted based on the materials used for the components and expected thermal expansion/contraction based on the materials (if any). The cover 602 utilizes the columns 602b to provide structural support while the thickness of cover 602 at the via areas 602a is reduced (e.g., 2-4 mm). This reduction may increase the sensitivity of the FOD loops on the FOD loop array 604 as compared to a base pad cover constructed from thicker material (e.g., 10 mm+). The columns 602b take advantage of the holes created by the FOD loops to provide structural reinforcement while allowing for relatively less base pad cover material between the FOD loop conductors and a potential foreign object located on the exterior of the cover.

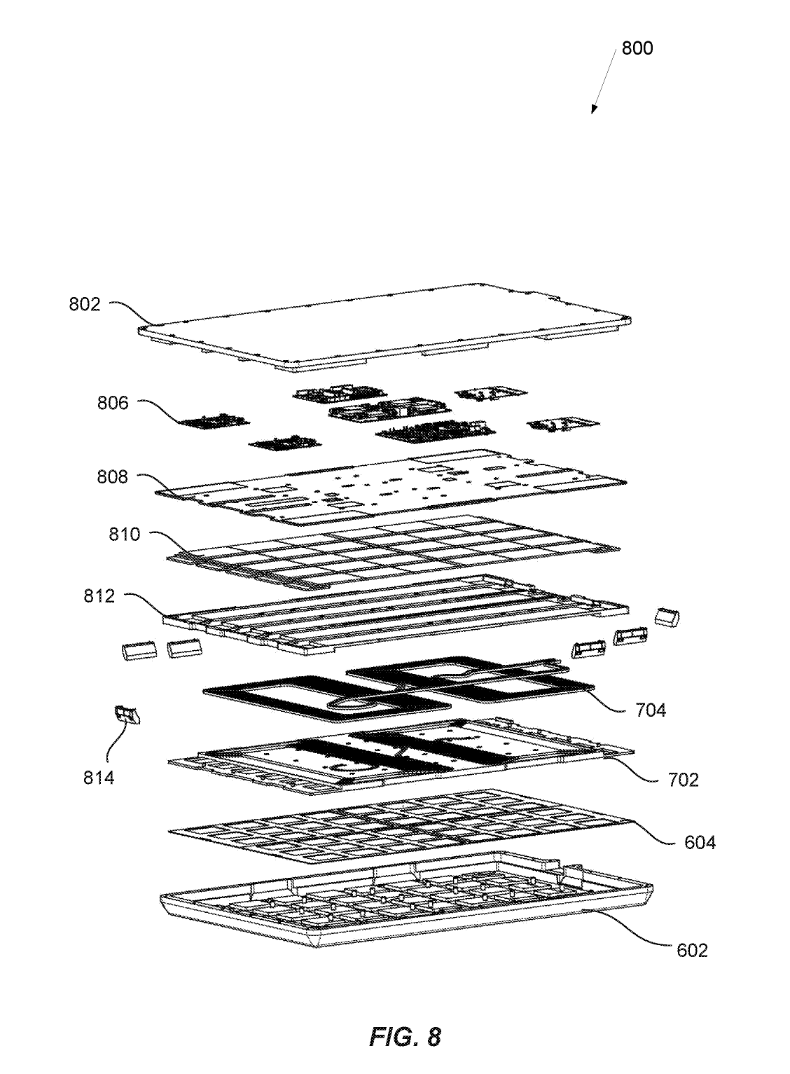

Referring to FIG. 8, with further reference to FIG. 6A and FIG. 7A, a perspective diagram of an example charging base pad 800 with a reinforced base pad cover 602 is shown. In operation, the charging base pad 800 may be installed such that the reinforced base pad cover 602 is directed upwards towards a vehicle pad (not shown in FIG. 8). In an example, the charging base pad 800 may be configured as a wireless electric vehicle pad disposed beneath a vehicle such that the reinforced base pad cover 602 is directed downwards towards a charging pad. The charging base pad 800 includes a reinforced base pad cover 602, a FOD loop array 604, a coil holder 702, a coil 704, a plurality of LOP sensors 814, a ferrite holder 812, a plurality of ferrites 810, an aluminum plate 808, a plurality of circuit boards 806, and a bottom cover 802. The components in the charging base pad 800 are exemplary only and not a limitation as other base pad configurations may be used with the reinforced base pad cover 602. For example, other ferrite and coil configurations such as circular, bi-polar, and solenoid type magnetic flux devices may be used in place of the double-D coil. The reinforced base pad cover 602 includes a plurality of columns 602b as depicted in FIG. 6A. The FOD loop array 604 may be comprised of a planar substrate such as a PCB with conductive loops. The FOD loop array 604 may include a plurality of operably coupled sub-array boards. For example a 6×8 loop array may be assembled from four 3×4 sub-array boards. The number and dimensions of the FOD loops are exemplary only as other combinations of arrays and sub-arrays may be used. The columns 602b on the reinforced base pad cover 602, the FOD loop centers 604b on the FOD loop array 604, and the slots 708a in the coil holder assembly 702 are of compatible geometry and dimensions such that they may be (e.g., stacked) as depicted in FIG. 7B.

In an embodiment, the charging base pad 800 may include one or more ferrites 810 and the ferrite holder 812. In an example, the ferrite holder 812 may be constructed of an industrial plastic such as PET. The ferrites 810 may be configured to modify the magnetic flux pattern of the charging base pad 800 during charging operations. The aluminum plate 808 may be disposed adjacent to the ferrites 810 and configured to support one or more PCBs 806. The PCBs 806 may be operably coupled to the FOD loop array 604, the LOP sensors 814 and the coil 704. For example, the PCBs 806 may include control systems configured to detect signals from the FOD and LOP systems. In an embodiment, a litz shield (not shown in FIG. 8) may be used with a double-D coil configuration to shield the PCBs from potential electromagnetic interference radiating from the coil conductors. Other shielding structures may also be included. The bottom cover 802 is configured enclose the components within the reinforced base pad cover 602. The bottom cover 802 may be secured to bottom cover 802 with one or more fasteners, clips, o-rings springs, or other mechanical fastener assemblies. For example, one or more non-ferrous bolts may be inserted through the charging base pad 800 via the plurality of assembly channels 605. In an embodiment, the back cover may be affixed to the reinforced base pad cover with adhesives and/or thermal processes (e.g., plastic welding).

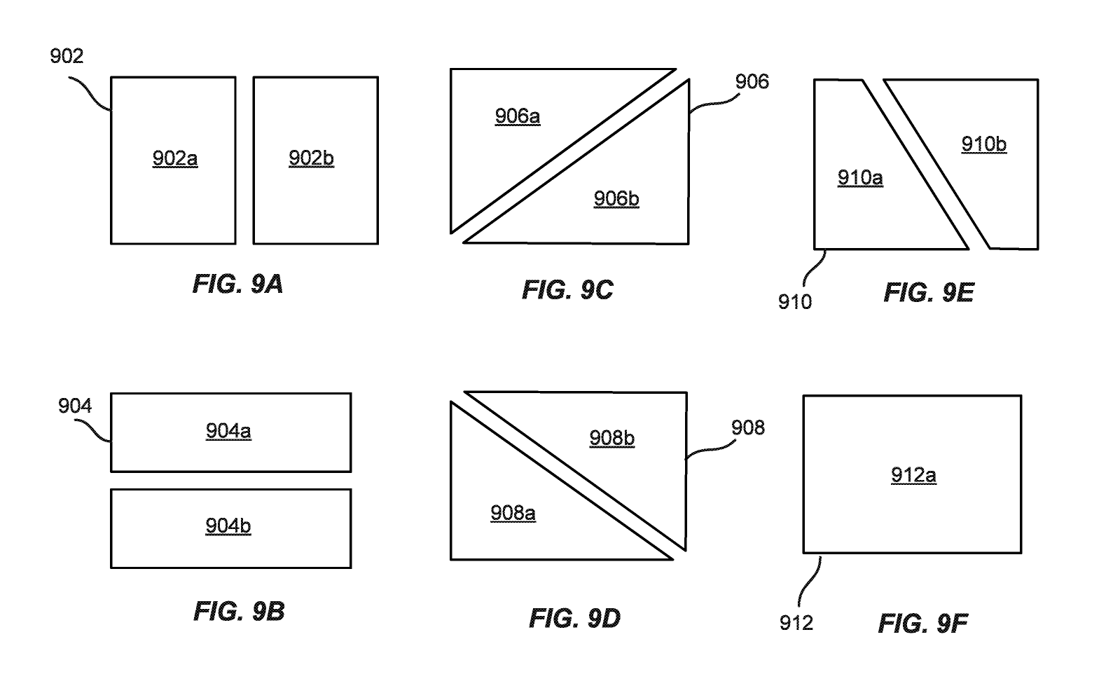

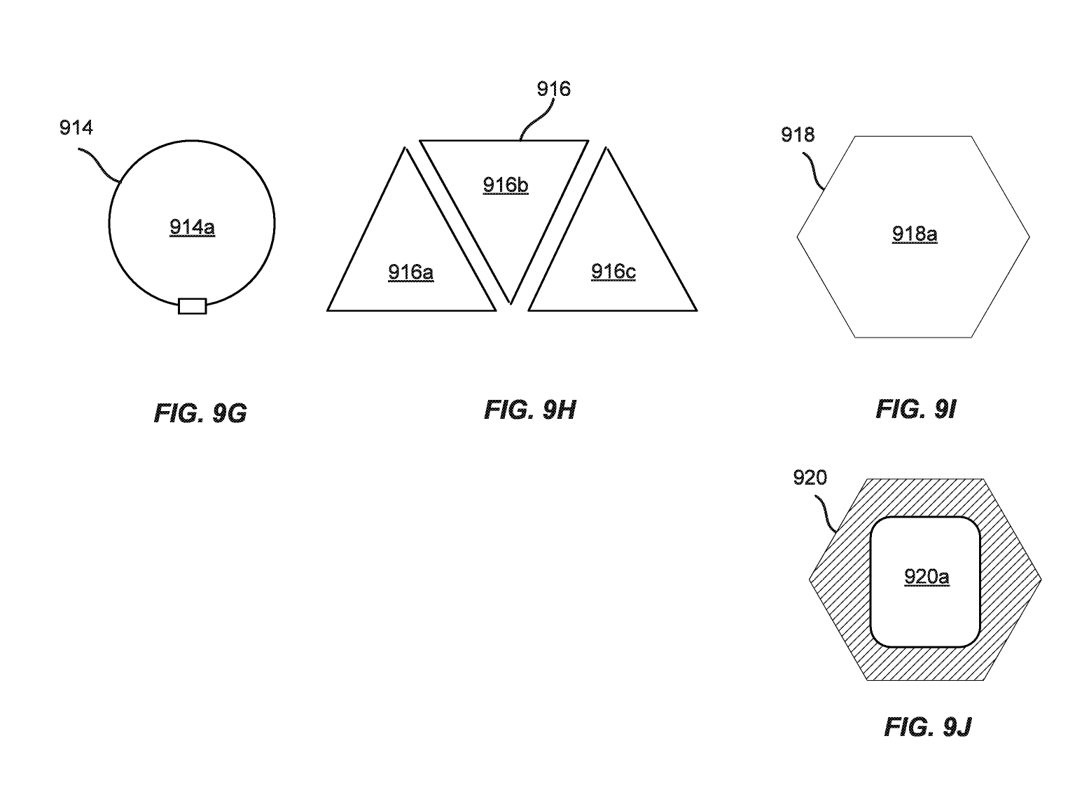

Referring to FIGS. 9A-9J, with further reference to FIGS. 6A-7B, schematic diagrams of exemplary FOD loop configurations are shown. Each of the FOD loop configurations in FIGS. 9A-9j are examples of a FOD loop configurations that may be used in one or more elements of a FOD loop array 604 and the corresponding FOD loop centers 604b. The columns 602b on the reinforced base pad cover 602 and the slots 708a in the coil holder assembly 702 may be of compatible geometry and dimensions to the loop configurations depicted in FIGS. 9A-9J. The configurations and orientations of the FOD loop configurations are exemplary only and not a limitation as other configurations and orientations may be used. FIG. 9A illustrates a double loop 902 (e.g., DD loop) with a first loop center 902a and a second loop center 902b. FIG. 9B illustrates another double loop 904 with a first loop center 904a and a second loop center 904b. The double loop 904 is in a different orientation as compared to the double loop 902 in FIG. 9A, with the double loop 902 being further oriented along an x-axis and the double loop 904 being further oriented along a y-axis (y-axis oriented in 90 degrees compared to the corresponding x-axis). FIGS. 9C and 9D illustrate diagonally oriented double loops 906, 908 with respective first and second loop centers 906a, 906b, 908a, 908b. The diagonally oriented double loops 906, 908 are oriented along a diagonal axis between the x-axis and the y-axis. The dimensions and angle of the FOD loops are exemplary only and not a limitation as the angle may be increased or decreased to change the off-axis sensitivity. For example, referring to FIG. 9E, the double loop 910 with a first loop center 910a and a second loop center 910b illustrates an example of a diagonally oriented double loop with a different axis of symmetry. FIG. 9F illustrates a circular loop 912 with a single loop center 912a. The circular loop 912 is an example of an FOD loop depicted in FIG. 6A. The circular loop 912 may also be further oriented in the x-y plane (e.g., rotated within the FOD array). FIG. 9G illustrates and another example of a circular loop 914 with a circular or oval loop center 914a. FIGS. 9H. 9I and 9J illustrate examples of other polygon loops such as a triangle loops 916 and a hexagon loop 918. The triangle loops 916 may include a plurality of loop centers 916a, 916b, 916c. The hexagon loop 918 includes a hexagon shaped loop center 918a. FIG. 9J is an example of a FOD loop where a loop center is a first geometry and the FOD loop is a second geometry that is different from the first geometry. For example, a hexagon loop 920 may have a rectangular loop center 920a. In this example, the columns 602b on the reinforced base pad cover 602 and the slots 708a are also rectangular based on the dimensions of the rectangular loop center 920a. As an example, the length and width dimensions of the FOD loops may range between 40 mm×28 mm to 200 mm×150 mm. The dimensions may also vary based on other charging system dimensions (e.g., base pad size) and performance requirements (e.g., sensitivity). The rectangular shapes and orientations of the FOD loops in FIGS. 9A-9J are exemplary only, and not a limitation, as other orientations and geometric antenna shapes may be used (e.g., circular, circular-rectangle, oval, triangular, or other polygons).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Plural instances may be provided for components, operations, or structures described herein as a single instance. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

As used herein, including in the claims, unless otherwise stated, a statement that a function or operation is “based on” an item or condition means that the function or operation is based on the stated item or condition and may be based on one or more items and/or conditions in addition to the stated item or condition.

For purposes of summarizing the disclosure, certain aspects, advantages and novel features have been described herein. It is to be understood that not necessarily all such advantages may be achieved in accordance with any particular implementation. Thus, one or more implementations achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. A wireless electric vehicle pad with a foreign object detection system, comprising:
a reinforced base pad cover including an interior side with a plurality of columns; and
a foreign object detection loop array comprising a plurality of loop centers, the foreign object detection loop array being disposed on the interior side of the reinforced base pad cover such that each of the plurality of loop centers is disposed around a corresponding column in the plurality of columns.

2. The wireless electric vehicle pad of claim 1 further comprising:
a coil holder including a first side and a second side, wherein the second side includes a plurality of slots and is disposed on the foreign object detection loop array such that each of the plurality of slots is disposed around a corresponding column in the plurality of columns; and
at least one coil disposed on the first side of the coil holder.

3. The wireless electric vehicle pad of claim 1 wherein the foreign object detection loop array comprises at least one planar substrate with a plurality of conductors disposed on or within the at least one planar substrate.

4. The wireless electric vehicle pad of claim 1 wherein the foreign object detection loop array comprises at least one wire loop disposed around each of the plurality of columns.

5. The wireless electric vehicle pad of claim 1 wherein the plurality of columns and the plurality of loop centers are rectangular in shape.

6. The wireless electric vehicle pad of claim 1 wherein the plurality of columns and the plurality of loop centers are oval shaped.

7. The wireless electric vehicle pad of claim 1 wherein the plurality of columns and the plurality of loop centers are triangularly shaped.

8. The wireless electric vehicle pad of claim 1 wherein the reinforced base pad cover consists of a polyethylene terephthalate material.

9. The wireless electric vehicle pad of claim 8 wherein at least a portion of the polyethylene terephthalate material is between 2 mm and 4 mm thick.

10. The wireless electric vehicle pad of claim 1 comprising 64 columns and 64 loop centers.

11. The wireless electric vehicle pad of claim 1 comprising 32 columns and 32 loop centers.

12. A charging base pad, comprising:
a reinforced base pad cover including an interior side with plurality of columns;
a foreign object detection loop array comprising a planar substrate with a plurality of loop centers, the foreign object detection loop array being disposed on the interior side of the reinforced base pad cover such that each of the plurality of loop centers is disposed around a corresponding column in the plurality of columns;
a coil holder including a first side and a second side, the second side including a plurality of slots and disposed on the foreign object detection loop array such that each of the plurality of slots is disposed around a corresponding column in the plurality of columns; and
at least one coil disposed on the first side of the coil holder.

13. The charging base pad of claim 12 wherein the at least one coil comprises litz wire wound in a double-D configuration.

14. The charging base pad of claim 12 wherein the foreign object detection loop array comprises at least one printed circuit board with a plurality of conductors disposed on or within the at least one printed circuit board.

15. The charging base pad of claim 12 wherein the plurality of columns, the plurality of loop centers and the plurality of slots are rectangular in shape.

16. The charging base pad of claim 12 wherein the plurality of columns, the plurality of loop centers and the plurality of slots are oval shaped.

17. The charging base pad of claim 12 wherein the plurality of columns, the plurality of loop centers and the plurality of slots are triangularly shaped.

18. The charging base pad of claim 12 wherein the reinforced base pad cover consists of a polyethylene terephthalate material.

19. The charging base pad of claim 18 wherein at least a portion of the polyethylene terephthalate material is between 2 mm and 4 mm thick.

20. The charging base pad of claim 12 further comprising at least one ferrite disposed in proximity to the at least one coil.

21. The charging base pad of claim 12 comprising 64 columns, 64 loop centers and 64 slots.

22. The charging base pad of claim 12 comprising 32 columns, 32 loop centers and 32 slots.

23. A wireless charging pad with a foreign object detection system, comprising:
a reinforced base pad cover including an interior side with a plurality of columns; and
a foreign object detection loop array comprising a plurality of loop centers, the foreign object detection loop array being disposed on the interior side of the reinforced base pad cover such that each of the plurality of loop centers is disposed around a corresponding column in the plurality of columns.

24. The wireless charging pad of claim 23 further comprising:
a coil holder including a first side and a second side, wherein the second side includes a plurality of slots and is disposed on the foreign object detection loop array such that each of the plurality of slots is disposed around a corresponding column in the plurality of columns; and
at least one coil disposed on the first side of the coil holder.

25. The wireless charging pad of claim 23 wherein the foreign object detection loop array comprises at least one printed circuit board with a plurality of conductors disposed on or within the at least one printed circuit board.

26. The wireless charging pad of claim 23 wherein the foreign object detection loop array comprises at least one wire loop disposed around each of the plurality of columns.

27. The wireless charging pad of claim 23 wherein the reinforced base pad cover consists of a polyethylene terephthalate material.

28. The wireless charging pad of claim 27 wherein at least a portion of the polyethylene terephthalate material is between 2 mm and 4 mm thick.

29. The wireless charging pad of claim 23 comprising 64 columns and 64 loop centers.

30. The wireless charging pad of claim 23 comprising 32 columns and 32 loop centers.
